(19) United States
(12) Patent Application Publication
(10) Pub. No.: US 2015/0300926 A1
(43) Pub. Date: Oct. 22, 2015

(54) WET-FILM PARTICLE IMPACTOR

(71) Applicant: Institute of Labor, Occupational Safety and Health, New Taipei City (TW)

(72) Inventors: Shi-Nian UANG, New Taipei City (TW); Chuen-Jinn TSAI, Hsinchu (TW); Shao-Ming HUNG, New Taipei City (TW)

(73) Assignee: Institute of Labor, Occupational Safety and Health, New Taipei City (TW)

(21) Appl. No.: 14/254,336

(22) Filed: Apr. 16, 2014

(51) Int. Cl. G01N 1/22

(52) U.S. Cl. CPC G01N 1/2208

(57) ABSTRACT

A wet-film particle impactor includes a housing, a nozzle, an impact surface and at least one water inlet. The housing defines a chamber therein and has an air outlet and a water outlet. The nozzle is disposed on the housing and has a plurality of through holes in communication with an air inlet and the chamber. The water inlet is formed on the impact surface for introducing water into the chamber. Whereby, the wet-film particle impactor is adapted to introduce the particle-containing air stream into the chamber sequentially via the air inlet and the through holes. The particles in the air stream are collected by the impact surface. The water introduced from the water inlet flushes the impact surface, carries the particles collected by the impact surface, and then exits the chamber via the water outlet.

### BACKGROUND OF THE INVENTION

1. Field of the Invention

The present invention relates generally to a particle sampler, and more specifically to a particle impactor.

2. Description of the Related Art

There are more and more nano-scale products available in the market, and therefore there is a good chance that some of the nano particles are released during the preparation and utilization of these products. Many researches have shown the influences of the nano particles to human bodies. In order to evaluate the hazard rating of the nano particles, sampling and subsequence analysis of the nano particles are essential.

Particle impactor is a common type of particle samplers, in which an impact plate is disposed perpendicular to an air stream injected from a nozzle, and thereby particles above a certain size possess so much momentum that they cannot follow the air stream, strike the impact plate and thus collected thereby.

However, particle bouncing usually occurs when the particles strike the impact plate. Such fact leads to unsatisfying particle collection result and consequently lowers the collection efficiency of the impact plate. Besides, particles can accumulate on the impact plate as the sampling processes goes on. Such accumulated particles could interfere with the collection of subsequent particles and worsen the particle bouncing effect.

### SUMMARY OF THE INVENTION

It is a main objective of the present invention to provide a particle impactor which can mitigate the particle bouncing effect.

To achieve the above and other objectives of the present invention, a wet-film particle impactor for collecting particles in an air stream is provided. The wet-film particle impactor includes a housing, a nozzle, an impact surface and at least one water inlet. The housing defines a chamber therein and has an air outlet and a water outlet, both of which are in communication with the chamber respectively. The nozzle is disposed on the housing and has a plurality of through holes in communication with an air inlet and the chamber. The impact surface is located in the chamber and facing the through holes. The water inlet is formed on the impact surface for introducing water into the chamber. Whereby, the wet-film particle impactor is adapted to introduce the particle-containing air stream into the chamber sequentially via the air inlet and the through holes. At least a part of the particles in the air stream are collected by the impact surface, and the air stream is then expelled from the chamber via the air outlet. The water introduced from the water inlet flushes the impact surface, carries the particles collected by the impact surface, and then exits the chamber via the water outlet.

The following detailed description will further explain the full scope of applications for the present invention. However, it should be understood that the detailed description and specific examples, while indicating preferred embodiments of the invention, are given by way of illustration only, since various changes and modifications within the spirit and scope of the invention will become apparent to those with the proper technical knowledge from this detailed description.

### BRIEF DESCRIPTION OF THE DRAWINGS

The present invention can be understood more fully by referring to the detailed description below, as well as the accompanying drawings. However, it must be understood that both the descriptions and drawings are given by way of illustration only, and thus do not limit the present invention.

FIG. 1 is a profile of the wet-film particle impactor of the preferable embodiment of the present invention;

FIG. 2 is a diagram showing particle collection efficiency vs. particle diameter with and without water introduction;

FIG. 3 is a diagram showing particle collection efficiency vs time with and without water introduction.

### DETAILED DESCRIPTION OF THE INVENTION

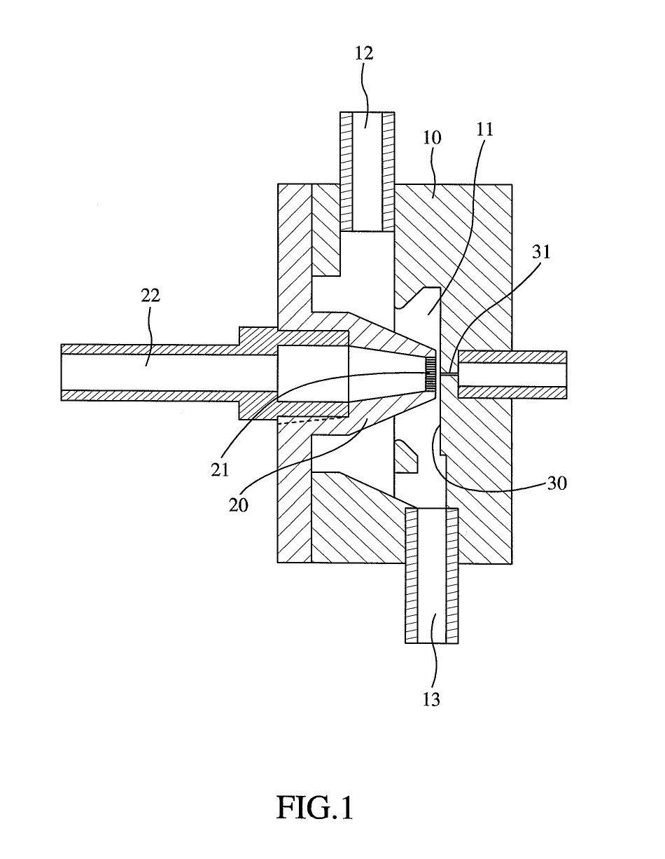

Please refer to FIG. 1 for a wet-film particle impactor in accordance with a preferable embodiment of the present invention. The wet-film particle impactor includes a housing 10, a nozzle 20 and an impact surface 30. The wet-film particle impactor is adapted to collect particles in the air stream, and more specifically to collect particles within certain size range. The wet-film particle impactor can be utilized independently or can cooperate with other particle sampler(s), such as cyclone dust collector and/or filter cassette.

The housing 10 defines a chamber 11 therein, and the housing 10 has an air outlet 12 and a water outlet 13, both of which are in communication with the chamber 11 respectively.

The nozzle 20 is disposed on the housing 10 and has a plurality of through holes 21 in communication with an air inlet 22 and the chamber 11.

The impact surface 30 is located in the chamber 11 and faces the through holes 21. At least one water inlet 31 is formed on the impact surface 30 for introducing flushing water, e.g. ultrapure water, into the chamber 11. In the present embodiment, the impact surface 30 is actually a part of the housing 10 which defines a boundary of the chamber 11. Alternatively, the impact surface 30 can be an impacting plate (not shown) distinct from the housing 10.

By means of the aforementioned design, the wet-film particle impactor is adapted to introduce the particle-containing air stream into the chamber 11 sequentially via the air inlet 22 and the through holes 21. At least a part of the particles in the air stream can strike the impact surface 30 and thus collected thereby. The air stream is then expelled from the chamber 11 via the air outlet 12. The ultrapure water introduced from the water inlet 31 will be spread on the impact surface 30 because of the high speed air stream, and therefore the water can flush the impact surface 30 and meanwhile carry the particles collected by the impact surface 30. Thereafter, the water carrying the particles exits the chamber 11 via the water outlet 13. Such particle-containing water can be used as a water sample for ion chromatography treatment to separate particles having different diameters and analysis the concentration of soluble particle ions.

To prevent the ultrapure water from accumulating on the impact surface 30, the through holes 21 are arranged to extend in a horizontal direction, and the impact surface 30 is perpendicular to the horizontal direction. Thereby, the ultrapure water on the impact surface 30 can spontaneously flow downward due to the gravity. The water outlet 30 is preferably located beneath the impact surface 30, such that the particle-containing water sample can exit the chamber 11 more easily. The air outlet 12 and the water outlet 13 are made perpendicular to the horizontal direction in the present embodiment, and the air outlet 12 is located closer to the air inlet 22 than the water outlet 13 in the horizontal direction.

To uniformly spread the introduced water on the impact surface 30, the water inlet 31 can also be arranged to extend in the horizontal direction and face the through holes 21. Under the circumstances that there is only one water inlet 31, the water inlet 31 is preferably located in the geometric center of the through holes 21 as a whole. On the other hand, a plurality of water inlets 31 can also be provided on the impact surface 30 to acquire better particle flushing and collecting results. More preferably, the number of the water inlets 31 can be made equal to that of the through holes 21, while the water inlets 31 and the through holes 21 are arranged face to face respectively.

To verify the collection efficiency of the present invention, the following experiment has been made. Introducing an air stream into the chamber 11 at an air flow rate Q of 2.0 L/min via 5 through holes 21 each having a diameter Dₙ of 0.3 mm. Water is introduced into the chamber 11 via the water inlet 31 having a diameter of 0.3 mm and located in the geometric center of the through holes 21. An S/W value, which is a ratio of the diameter of each through hole 21 to a distance between the through holes 21 and the impact surface 30, is set at 5. The water flow rate Q_{w} of the experimental group is set at 3.3 L/min, while the water flow rate Q_{w} of the control group is set at 0 L/min.

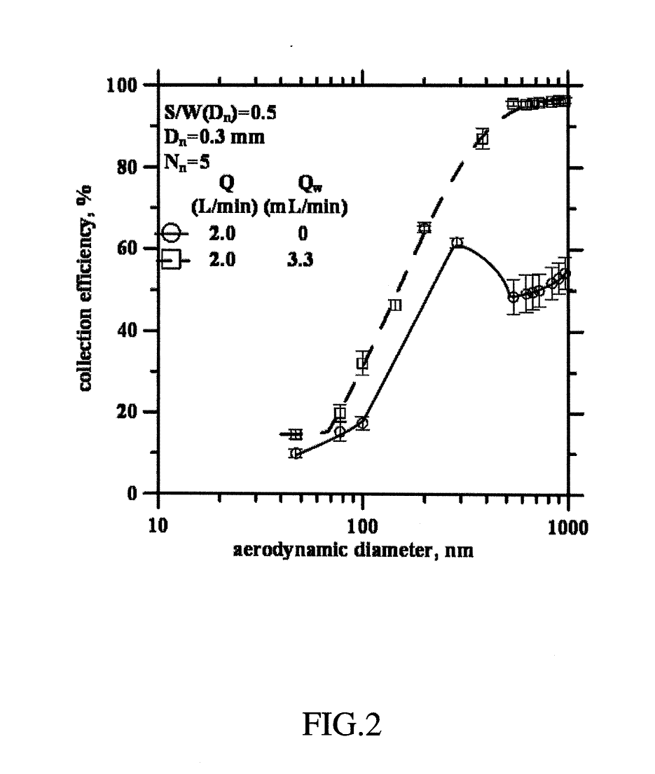

One of the test result is shown in FIG. 2. In the control group, which is processed without water introduction, the collection efficiency of the particles having diameters of 500 nm or more is only 50-60%. In the experimental group processed with water introduction, the collection efficiency of similar particles rises up to 95% or more, which indicates that the introduced water on the impact surface can effectively prevent the particles from bouncing. Also, the water can be helpful to flush the impact surface and carry the particles collected by the impact surface.

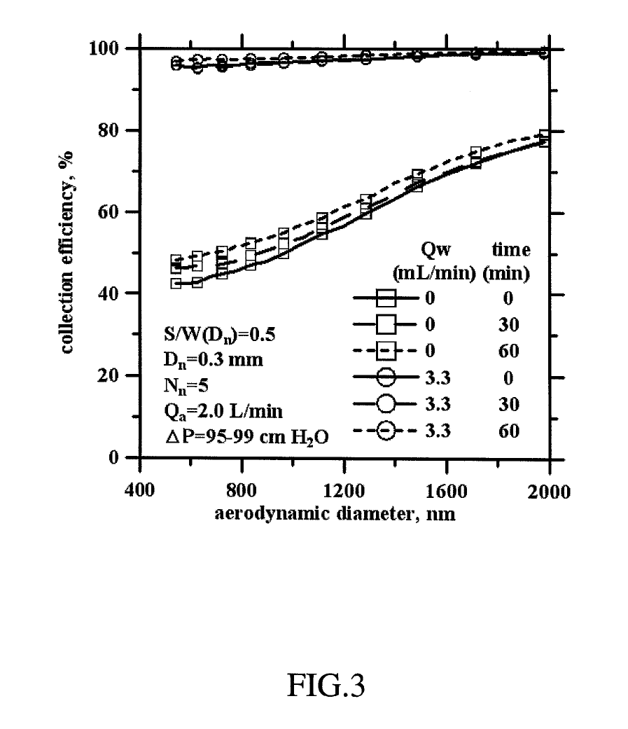

A result of the particulate loading test of particles having diameters of above 500 nm can be shown in FIG. 3. As shown in the diagram, the collection efficiency of the particle impactor of the present invention barely changes by the lapse of time, which indicates that there is nearly no particulate loading on the impact surface of the present invention. On the other hand, particle bouncing occurs on the impact surface of the control group without water introduction even in the early stage of the test. As a result, the collection efficiency of the control group is far lower than that of the present invention.

In light of the foregoing, particle bouncing can be effectively mitigated by introducing water from the water inlet formed on the impact surface. Accordingly, the particle collection efficiency of the particle impactor can be significantly elevated. More specifically, the introduced water can flush the impact surface and carry the collected particles on the impact surface, such that the impact surface remains at a state with nearly no particulate loading. Particle bouncing resulted from particle accumulation on the impact surface can thus be mitigated. In summarization, the present invention can effectively mitigate the disadvantages of conventional particle impactors, and therefore the objective of precise particle sampling can be achieved.

The invention described above is capable of many modifications, and may vary. Any such variations are not to be regarded as departures from the spirit of the scope of the invention, and all modifications which would be obvious to someone with the technical knowledge are intended to be included within the scope of the following claims.

What is claimed is:

1. A wet-film particle impactor for collecting particles in an air stream, comprising:
a housing, defining a chamber therein, the housing having an air outlet and a water outlet in communication with the chamber respectively;
a nozzle, disposed on the housing, the nozzle having a plurality of through holes in communication with an air inlet and the chamber;
an impact surface, located in the chamber and facing the through holes; and
at least one water inlet, formed on the impact surface for introducing water into the chamber;
whereby, the wet-film particle impactor is adapted to introduce the particle-containing air stream into the chamber sequentially via the air inlet and the through holes, at least a part of the particles in the air stream are collected by the impact surface, the air stream is then expelled from the chamber via the air outlet, the water introduced from the water inlet flushes the impact surface, carries the particles collected by the impact surface, and then exits the chamber via the water outlet.

2. The wet-film particle impactor of claim 1, wherein the through holes of the nozzle are arranged horizontally, the impact surface is perpendicular to the through holes.

3. The wet-film particle impactor of claim 1, wherein the water inlet is arranged horizontally, and the water inlet faces the through holes.

4. The wet-film particle impactor of claim 3, wherein the water outlet is located beneath the impact surface.
